(19) United States
(12) Patent Application Publication
(10) Pub. No.: US 2018/0074463 A1
(43) Pub. Date: Mar. 15, 2018

(54) Diet Watch

(71) Applicant: CZARNEK & ORKIN LABORATORIES, INC., Highland Park, IL (US)

(72) Inventor: Robert Czarnek, Johnstown, PA (US)

(21) Appl. No.: 15/703,206

(22) Filed: Sep. 13, 2017

Related U.S. Application Data
(60) Provisional application No. 62/394,435, filed on Sep. 14, 2016.

(51) Int. Cl. G04B 47/06; G04F 3/00

(52) U.S. Cl. CPC G04B 47/06; G04F 3/00

(57) ABSTRACT

A diet watch includes a housing with an adjustable wristband attached thereto, at least one accelerometer and/or gyroscope sensor and/or magnetometer disposed within the housing, a processor disposed within the housing and operatively coupled to the at least one accelerometer and/or gyroscope sensor and/or magnetometer, and a feedback device coupled to the processor. The at least one accelerometer and/or gyroscope sensor and/or magnetometer provides a signal related to an orientation and movement of a user's hand in space. The processor uses the signal from the at least one accelerometer and/or gyroscope sensor and/or magnetometer to determine that a bite was taken by the user and starting a timer to countdown a preset time interval. The feedback device provides an indication to the user that another bite of food may be taken after the preset time interval has elapsed.

### CROSS REFERENCE TO RELATED APPLICATION

This application claims priority to U.S. Provisional Patent Application No. 62/394,435, entitled “Diet Watch”, filed on Sep. 14, 2016, the disclosure of which is incorporated by reference herein in its entirety.

### BACKGROUND OF THE INVENTION

Field of the Invention

The present invention relates, in general, to a device for modifying behavior and, more particularly, to a device for slowing an individual's rate of food consumption.

Description of Related Art

Research shows that eating too fast has adverse effects for persons who are trying to maintain or lose weight, as well as in discouraging interaction of family members at a dining table. Medical research has shown that it takes approximately 20 minutes from the time we first start eating for the brain to signal a person that he/she is full or have had enough to eat. If a person eats too fast we consume more food than is necessary before the brain sends a signal that informs the person that he or she is full. Therefore, a means of slowing the rate of food ingestion will greatly aid in a dieting regimen and weight reduction program.

Another consequence of eating too fast is that it reduces conversation among persons at a dining table. If people leave considerable time between taking bites of food, this provides a more relaxed “social atmosphere” at the dining table. Such a more relaxed atmosphere encourages table conversation.

Currently, several devices exist for monitoring food consumption.

U.S. Pat. No. 7,855,936 B2 to Czarnek et al. discloses a diet watch that includes a housing with an adjustable wristband attached thereto, at least one accelerometer disposed within the housing, a microcontroller disposed within the housing and operatively coupled to the accelerometer and a feedback device operatively coupled to the microcontroller. The accelerometer provides a signal indicative of an orientation of a user's hand in space. The microcontroller uses the signal from the at least one accelerometer to determine that a bite was taken by the user and starting a timer to countdown a preset time interval. The feedback device provides an indication to the user that another bite of food may be taken after the preset time interval has elapsed.

U.S. Pat. No. 5,421,089 to Dubus et al. discloses a fork with timer comprising a fork having a head, a plurality of spaced tines extended from the head, and a handle extended from the head remote from the tines; timer circuitry connected to the handle of the fork and adapted for providing a cue after an elapsed period of time for indicating to user that another bite of food using the fork may be taken; a replaceable power source connected to the fork and coupled to the timer circuitry with the power source adapted for energizing the timer circuitry; and a switch connected to the fork and coupled between the power source and the timer circuitry with the switch having one orientation for energizing the timer circuitry and another orientation for de-energizing the timer circuitry.

U.S. Pat. No. 5,563,850 to Hanapole discloses a device for mounting on the wrist of an individual that includes a motion-sensing element that is coupled to and starts a timing unit when the wrist is moved, as in raising a utensil of food to the mouth. The timing unit is coupled to a signal generator that it actuates after a given interval of time. The signal generator actuates an annunciator unit, in contact with the wrist of the individual that produces a tangible sensation on the wrist of the individual to advise the individual that it is time for more food, and that the cycle can be repeated. The tangible sensation may be a physical prodding or and electrical stimulus.

U.S. Pat. No. 6,765,488 to Stanfield discloses a portable device that helps a person control food consumption by slowing the eating process to a pace that provides time for the human brain to signal a “sensation of fullness” before overeating or “binge eating” can occur. The device includes red and green lights, a circuit that controls energization of the lights and a pushbutton switch that operates a portion of a circuit. When the push button is depressed, the circuit energizes the red light for a predetermined wait period to indicate that the person should not eat. Then, the circuit energizes the green light to indicate that the person can take one or two bites of food at his/her convenience. After taking one or two bites, the person depresses the push button to cause the red light to be energized. This cycle continues until the meal is over.

However, each of the devices discussed above suffers from various drawbacks. For instance, a device such as the one disclosed by U.S. Pat. No. 5,563,850 utilizes only a simple tilt switch to detect the change of a single preset threshold. Such an approach is highly unreliable because it has no way in which to adapt to the physiology and/or habits of the user. It detects only a predetermined angle of the arm through a single axis of movement. Furthermore, devices such as the ones disclosed by U.S. Pat. Nos. 6,765,488 and 5,421,089 lack the ability to be discretely worn by the user.

Accordingly, a need exists for a device for monitoring the consumption of food that automatically starts a timer after each bite of food is taken based on the movement of a user's hand.

### SUMMARY OF THE INVENTION

Generally provided is an improvement to the Diet Watch disclosed in U.S. Pat. No. 7,855,936, which is incorporated by reference herein in its entirety.

According to one preferred and non-limiting embodiment or aspect, the addition of a gyroscope and/or magnetometer to the Diet Watch disclosed in U.S. Pat. No. 7,855,936 allows further refinement of the information about the movement of the hand. A software program implemented on the microprocessor can better differentiate between movement associated with taking a bite and a movement related to gesticulation during a conversation.

Recent advancements in technology resulted in availability of inertial measurement units that measure acceleration, rotational velocity and magnetic vector in a single affordable package that can be easily incorporated into the diet watch. An example of an inertial measurement unit is an LSM9DS1 Motion Measurement Unit (MMU) from ST Microelectronics, sometimes also called Inertial Measurement Units (IMU).

In a preferred and non-limiting embodiment, example, or aspect, the combination of two or more of the measured signals, i.e., acceleration, rotational velocity and magnetic vector, can be used to determine if the bite was taken and trigger the timer. Also the microprocessor can be programmed to recognize hand signals to select a desired function or change a parameter such as a time interval between the bites.

According to one preferred and non-limiting embodiment or aspect, provided is a diet watch including a housing with an adjustable wristband attached thereto, at least one of an accelerometer and/or at least one gyroscope and/or at least one magnetometer disposed within the housing, a processor disposed within the housing and operatively coupled to the accelerometer and a feedback device operatively coupled to the processor. The Motion Measurement Unit (MMU), which can include the accelerometer and/or the at least one gyroscope and/or the at least one magnetometer, can provide a signal indicative of an orientation and movement of a user's hand in space. The processor uses the signal(s) from one, or two or more of the accelerometer, the gyroscope, and/or the magnetometer to determine that a bite was taken by the user and starting a timer to countdown a preset time interval. The feedback device provides an indication to the user that another bite of food may be taken after the preset time interval has elapsed.

In one preferred and non-limiting embodiment or aspect, the diet watch may further include a user interface having at least one button that allows a user to program the processor. The at least one button may allow the user to set the preset time interval, to set the indication that the feedback device provides to the user or the like. The processor may be programmable to be customized to distinct movement patterns of the user. In a preferred and non-limiting embodiment, example, or aspect, the distinct movement patterns of the user can be determined through threshold memorization based on feedback provided by one or more of the accelerometer, the gyroscope, and/or the magnetometer. The feedback device may be a vibrator, buzzer, Light Emitting Diode (LED), or electric shock device. The feedback device may provide a signal to the user if the user attempts to take another bite of food before the preset time interval has elapsed. The button may be a simple switch or a touch sensor such as a capacitive sensor or resistive touch sensor.

In one preferred and non-limiting embodiment or aspect, the diet watch may further include a display screen positioned on the housing for providing a visual indication to the user of relevant information. The display screen may be a liquid crystal display (LCD) or a light emitting diode (LED) display. The accelerometer can use gravity as an input vector to determine the orientation of the user's hand in space, and may be a two-axis accelerometer or a three-axis accelerometer. The gyroscope can be a two axis gyroscope or a three axis gyroscope. The magnetometer can be a two-axis magnetometer or a three-axis magnetometer. An integrated accelerometer/ gyroscope sensing chip or an integrated accelerometer/gyroscope/magnetometer chip can be used as the sensor.

Further preferred and non-limiting embodiments or aspects are set forth in the following numbered clauses.
Clause 1: A diet watch can comprise: a housing with an adjustable wristband attached thereto; at least one of a gyroscope and a magnetometer disposed within the housing for providing a signal related to an orientation of a user's hand in space; a processor disposed within the housing and operatively coupled to the at least one of the gyroscope and the magnetometer for using at least one signal from the at least one of the gyroscope and the magnetometer to determine that a bite was taken by the user and starting a timer to countdown a preset time interval; and a feedback device operatively coupled to the processor for providing an indication to the user that another bite of food may be taken after the preset time interval has elapsed.
Clause 2: The diet watch of clause 1 can further comprise a user interface having at least one button that allows a user to program the processor to determine when the motion of the user's arm corresponds to the bite being taken by the user and when to ignore movement of the arm.
Clause 3: The diet watch of clause 1 or 2, wherein the at least one button can allow the user to set the preset time interval, to set the indication that the feedback device provides to the user, or the combination thereof.
Clause 4: The diet watch of any one of clauses 1-3, wherein the processor can be programmable to be customized to distinct movement patterns of the user based on feedback provided by the at least one of the gyroscope and the magnetometer.
Clause 5: The diet watch of any one of clauses 1-4, wherein the processor can be programmable to be customized to the distinct movement patterns of the user through threshold memorization.
Clause 6: The diet watch of any one of clauses 1-5 can further comprise a display screen positioned on the housing for providing a visual indication to the user of relevant information.
Clause 7: The diet watch of any one of clauses 1-6, wherein the display screen can be a liquid crystal display (LCD) or a light emitting diode (LED) display.
Clause 8: The diet watch of any one of clauses 1-7, wherein the magnetometer can use the earth's magnetic field as an input vector to determine the orientation of the user's hand in space and can output to the processor a signal related to the orientation of the user's hand in the space.
Clause 9: The diet watch of any one of clauses 1-8, wherein the gyroscope can measure an angular velocity of the user's hand in the space and can output to the processor a signal related to said angular velocity.
Clause 10: The diet watch of any one of clauses 1-9, wherein the processor can determine from the signal output by the gyroscope related to said angular velocity of the user's hand in the space the orientation of the user's hand in the space or a change in the orientation of the user's hand in the space.
Clause 11: The diet watch of any one of clauses 1-10, wherein the gyroscope can be a MEMS gyro chip.
Clause 12: The diet watch of any one of clauses 1-11, wherein the feedback device can be a vibrator, a buzzer, a Light Emitting Diode (LED), or an electric shock device.
Clause 13: The diet watch of any one of clauses 1-12, wherein the feedback device can provide a signal to the user if the user attempts to take another bite of food before the preset time interval has elapsed.
Clause 14: A diet watch can comprise: a housing with an adjustable wristband attached thereto; a gyroscope and a magnetometer disposed within the housing for providing signals related to an orientation of a user's hand in space; a processor disposed within the housing and responsive to the signals from the gyroscope and the magnetometer to determine that a bite was taken by the user and starting a timer to countdown a preset time interval; and a feedback device operatively coupled to the processor for providing an indication to the user that another bite of food may be taken after the preset time interval has elapsed.
Clause 15: The diet watch of clause 14, wherein the magnetometer can use the earth's magnetic field as an input vector to determine the orientation of the user's hand in space and can output to the processor a signal related to the orientation of the user's hand in the space.
Clause 16: The diet watch of clause 14 or 15, wherein the gyroscope can measure an angular velocity of the user's hand in the space and outputs to the processor a signal related to said angular velocity.
Clause 17: The diet watch of any one of clauses 14-16, wherein the processor determines from the signal output by the gyroscope related to said angular velocity of the user's hand in the space the orientation of the user's hand in the space or a change in the orientation of the user's hand in the space.
Clause 18: The diet watch of any one of clauses 14-17, wherein the gyroscope is a MEMS gyro chip.

### BRIEF DESCRIPTION OF THE DRAWINGS

Additional advantages and details of the invention are explained in greater detail below with reference to the exemplary preferred and non-limiting embodiments, examples, or aspects that are illustrated in the accompanying figures, in which:

FIG. 1 is a perspective view of one embodiment diet watch according to the principles of the present invention;

FIG. 2 is an electrical block diagram of one embodiment diet watch according to the principles of the present invention; and

FIG. 3 is an electrical schematic diagram of one embodiment diet watch according to the principles of the present invention.

### DESCRIPTION OF THE INVENTION

For the purposes of the following detailed description, it is to be understood that the invention may assume various alternative variations and step sequences, except where expressly specified to the contrary. It is also to be understood that the specific devices and methods described in the following specification are simply exemplary embodiments. Moreover, other than in any operating examples, or where otherwise indicated, all numbers expressing, in preferred and non-limiting embodiment, example, or aspect, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the Doctrine of Equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. Certain preferred and non-limiting embodiments or aspects of the present invention will be described with reference to the accompanying figures where like reference numbers correspond to like or functionally equivalent elements.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

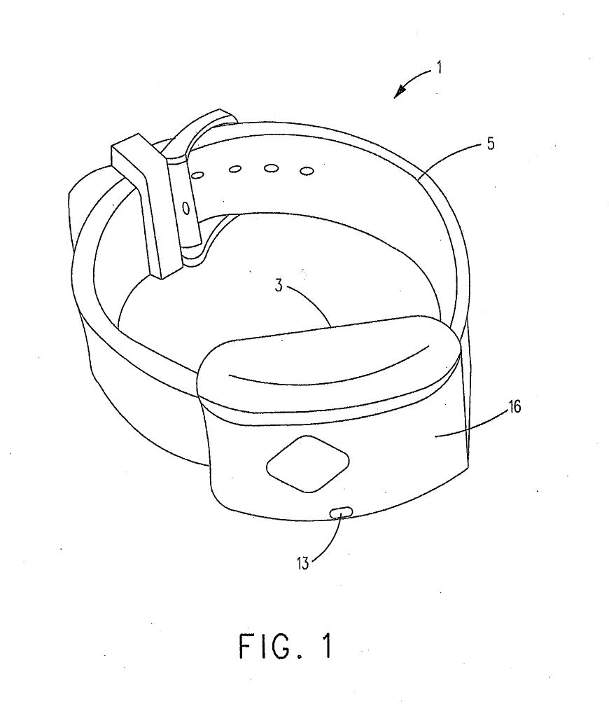

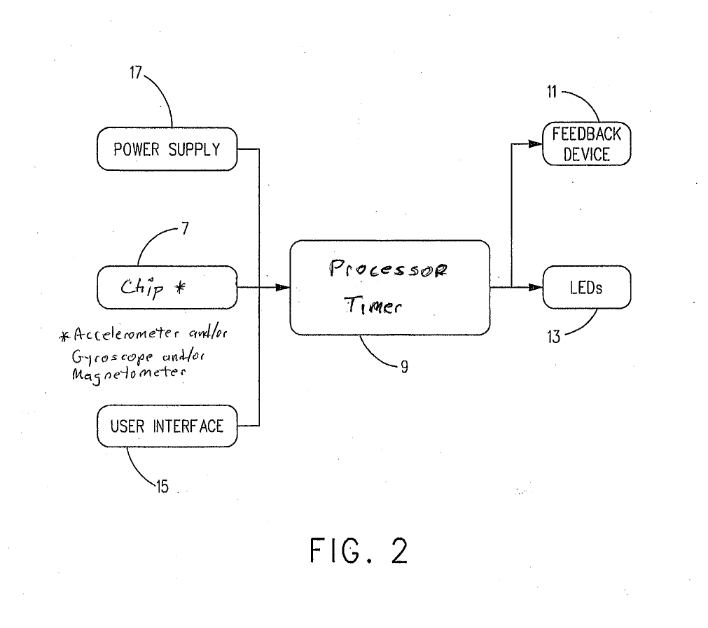

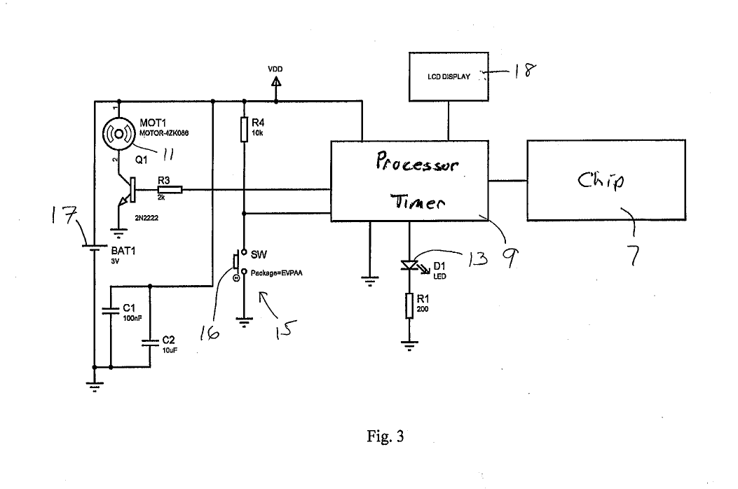

With reference to FIGS. 1-3, one preferred and non-limiting embodiment, example, or aspect diet watch 1 can include a housing 3 with an adjustable wristband 5 attached thereto. Adjustable wristband 5 may be any suitable band for attaching the device to the wrist of a user including, in one preferred and non-limiting embodiment, example, or aspect, an elastic band, a band with a VELCRO fastening means, a band with a buckle-type fastening means or the like.

In a preferred and non-limiting embodiment, example, or aspect, a chip 7 can be disposed within housing 3 to provide a signal indicative of an orientation of a user's hand in space. In a preferred and non-limiting embodiment, example, or aspect, the, chip 7 can be an accelerometer that uses gravity as an input vector to determine the orientation of the user's hand in space. The accelerometer can be a two-axis accelerometer or a three-axis accelerometer.

In a preferred and non-limiting embodiment, example, or aspect, a processor 9 can also be disposed within housing 3 and can be operatively coupled to the chip 7. The use of the accelerometer, in combination with processor 9 operating under the control of a software program, can allow for diet watch 10 to determine that a bite has been taken regardless of the type of motion the user implements while eating.

In a preferred and non-limiting embodiment, example, or aspect, eating with a fork or spoon can be a complex series of motions that can depend on individual physiology. For example, one use of a fork may require a stick motion into a morsel of food, a wrist turn and an arm lift to the mouth. In a preferred and non-limiting embodiment, example, or aspect, the use of a spoon, by contrast, can have a scooping initial move followed by a much smaller angle of wrist turn to avoid a spill and a different angle of approach to the mouth as the user's head lowers much further to meet the spoon.

In a preferred and non-limiting embodiment, example, or aspect, the use of the accelerometer coupled to processor 9 operating under the control of a software program allows for diet watch 1 to monitor both wrist and arm movement accurately. In a preferred and non-limiting embodiment, example, or aspect, the accelerometer can be a device that continuously measures components of acceleration vector. Under the control of the software program, processor 9 can calculate vector direction and can compare vector variations with variables programmed by the user into a memory accessible by processor 9. In this manner, the user can program diet watch 1 to determine when the motion of the user's arm corresponds to a bite of food being taken and when diet watch 1 should ignore the movement of the arm.

In a preferred and non-limiting embodiment, example, or aspect, diet watch 1 can also include a feedback device 11 disposed at least partially within housing 3 and is operatively coupled to processor 9. In a preferred and non-limiting embodiment, example, or aspect, feedback device 11 can provide an indication to the user that another bite of food may be taken. In a preferred and non-limiting embodiment, example, or aspect, feedback device 11 can be, but is not limited to, a vibrator, a buzzer, a Light Emitting Diode (LED), or an electric shock device. In a preferred and non-limiting embodiment, example, or aspect, feedback device 11 can also be configured to provide a signal to the user if the user attempts to take another bite of food before the preset time interval has elapsed.

In a preferred and non-limiting embodiment, example, or aspect, diet watch 1 can further include at least one LED 13 disposed at least partially within housing 3 and operatively coupled to processor 9. LED 13 can provide information to the user of the mode of operation of diet watch 1. In a preferred and non-limiting embodiment, example, or aspect, LED 13 may be capable of emitting green and red light. When LED 13 is emitting a green light, the user may take a bite of food; and when LED 13 is emitting a red light, the user is provided with an indication that a bite of food should not be taken.

In a preferred and non-limiting embodiment, example, or aspect, diet watch 1 can also include a user interface 15 having at least one button 16 that allows for a user to program processor 9. In a preferred and non-limiting embodiment, example, or aspect, the at least one button 16 may allow the user to set a preset time interval, set the indication that the feedback device provides to the user, or the like.

In a preferred and non-limiting embodiment, example, or aspect, an LCD display 18 may also be incorporated into housing 3 to provide the user with a visual indication of such items including, but not limited to, the preset time interval or the like. In a preferred and non-limiting embodiment, example, or aspect, diet watch 1 can further include a power supply 17 for providing power to each component of the device. Power supply 17 may be any suitable power supply such as, but not limited to, a disposable battery, a rechargeable battery or the like.

In a preferred and non-limiting embodiment, example, or aspect, in operation, the user first programs processor 9 using user interface 15 to customize diet watch 1 to distinct movement patterns of the user's arm and wrist. In a preferred and non-limiting embodiment, example, or aspect, the distinct movement patterns of the user's arm and wrist can be determined through threshold memorization based on feedback provided by accelerometer 7. Accelerometer 7 can provide a signal or signals indicative of an orientation and/or movement of a user's hand in space. Processor 9 can use the signal(s) from the accelerometer 7 to determine that a bite of food was taken by the user. Processor 9 can then start a timer to countdown a preset time interval. In a preferred and non-limiting embodiment, example, or aspect, the timer can be an internal timer of processor 9.

In a preferred and non-limiting embodiment, example, or aspect, once the preset time interval has elapsed, processor 9 can cause feedback device 11 to provide an indication to the user that another bite of food may be taken. In a preferred and non-limiting embodiment, example, or aspect, processor 9 can cause feedback device 11 to provide a signal to the user if the user attempts to take another bite of food before the preset time interval has elapsed. In this manner, diet watch 1 has the ability to slow the rate of food consumption of a user.

In a preferred and non-limiting embodiment, example, or aspect, chip 7 can be a gyroscope. The word “gyroscope” is used herein to describe a Micro-Electro-Mechanical Systems (MEMS) gyro chip. Such MEMS devices measure the angular velocity rather than angle of rotation. However, using integration by processor 9, the angle of rotation can be calculated.

In a preferred and non-limiting embodiment, example, or aspect, MEMS gyro chips can be integrated with other sensors such as MEMS accelerometers, magnetometers, barometric pressure sensors and temperature sensors. Examples of such chips can include LSM9DS1 and LSM9DSO made by ST Electronics, MPU-9250 from InvenSense, and BMX055 from Bosch. Some manufacturers integrate individual sensor chips into multi-sensor modules such as, for example, an MM7150-AB1 from Microchip Technology, but such devices are less practical in this application due to their larger size and higher cost.

In a preferred and non-limiting embodiment, example, or aspect, in operation, the user first programs processor 9 using user interface 15 to customize diet watch 1 to distinct movement patterns of the user's arm and wrist. In a preferred and non-limiting embodiment, example, or aspect, the distinct movement patterns of the user's arm and wrist can be determined through threshold memorization based on feedback provided by the gyroscope. Thereafter, the gyroscope can provide a signal indicative of or related to movement or orientation of a user's hand in space or a change in the orientation of the user's hand in space. In a preferred and non-limiting embodiment, example, or aspect, processor 9, operating under the control of the software program, can use the signal from the gyroscope to determine that a bite of food was taken by the user.

In a preferred and non-limiting embodiment, example, or aspect, the gyroscope outputs a signal indicative of the angular velocity of the user's hand in space. Under the control of the software program, processor 9 can integrate the signal indicative of the angular velocity of the user's hand in space thereby determining the orientation or rotation of the user's hand in space.

Next, under the control of the software program, processor 9 can then start the internal timer to countdown a preset time interval. Once the preset interval has elapsed, processor 9 can cause feedback device 11 to provide an indication to the user that another bite of food may be taken. Operating under the control of the software program, processor 9 can cause feedback device 11 to provide a signal to the user if the user attempts to take another bite of food before the preset time interval has elapsed. In this manner, diet watch 1 has the ability to slow the rate of food consumption of a user.

In a preferred and non-limiting embodiment, example, or aspect, chip 7 can be a magnetometer. In operation, the user first programs processor 9 using user interface 15 to customize diet watch 1 to distinct movement patterns of the user's arm and wrist. In a preferred and non-limiting embodiment, example, or aspect, the distinct movement patterns of the user's arm and wrist can be determined through threshold memorization based on feedback provided by the magnetometer. Thereafter, the magnetometer can provide a signal related to an orientation of a user's hand in space with respect to the earth's magnetic field. In a preferred and non-limiting embodiment, example, or aspect, processor 9, operating under the control of the software program, can use the signal from the magnetometer to determine that a bite of food was taken by the user. If so, and under the control of the software program, processor 9 can then start the internal timer to countdown a preset time interval. Once the preset interval has elapsed, processor 9 can cause feedback device 11 to provide an indication to the user that another bite of food may be taken. Operating under the control of the software program, processor 9 can cause feedback device 11 to provide a signal to the user if the user attempts to take another bite of food before the preset time interval has elapsed. In this manner, diet watch 1 has the ability to slow the rate of food consumption of a user.

In a preferred and non-limiting embodiment, example, or aspect, chip 7 can be a motion measurement unit (MMU) that incorporates the functions of two or more of an accelerometer, a gyroscope, and a magnetometer. In a preferred and non-limiting embodiment, example, or aspect, an example of such chip 7 is an LSM9DS1 Motion Measurement Unit commercially available from ST Microelectronics. In operation, the user first programs processor 9 using user interface 15 to customize diet watch 1 to distinct movement patterns of the user's arm and wrist. In a preferred and non-limiting embodiment, example, or aspect, the distinct movement patterns of the user's arm and wrist can be determined through threshold memorization based on feedback provided by the combination of two or more of the accelerometer, the gyroscope, and the magnetometer, which provide signals indicative of or related to an orientation, movement, or both of a user's hand in space. In a preferred and non-limiting embodiment, example, or aspect, processor 9, operating under the control of the software program, can use the combination of these signals to determine that a bite of food was taken by the user. If so, and under the control of the software program, processor 9 can then start the timer to countdown a preset time interval. Once the preset interval has elapsed, processor 9 can cause feedback device 11 to provide an indication to the user that another bite of food may be taken. Operating under the control of the software program, processor 9 can cause feedback device 11 to provide a signal to the user if the user attempts to take another bite of food before the preset time interval has elapsed. In this manner, diet watch 1 has the ability to slow the rate of food consumption of a user.

As can be seen, disclosed herein is one preferred and non-limiting embodiment, example, or aspect diet watch comprising: a housing with an adjustable wristband attached thereto; at least one of a gyroscope and a magnetometer disposed within the housing for providing a signal related to an orientation of a user's hand in space; a processor disposed within the housing and operatively coupled to the at least one of the gyroscope and the magnetometer for using at least one signal from the at least one of the gyroscope and the magnetometer to determine that a bite was taken by the user and starting a timer to countdown a preset time interval; and a feedback device operatively coupled to the processor for providing an indication to the user that another bite of food may be taken after the preset time interval has elapsed.

In one preferred and non-limiting embodiment, example, or aspect, the diet watch can further include a user interface having at least one button that allows a user to program the processor to determine when the motion of the user's arm corresponds to the bite being taken by the user and when to ignore movement of the arm.

In one preferred and non-limiting embodiment, example, or aspect, the at least one button can allow the user to set the preset time interval, to set the indication that the feedback device provides to the user, or the combination thereof.

In one preferred and non-limiting embodiment, example, or aspect, the processor can be programmable to be customized to distinct movement patterns of the user.

In one preferred and non-limiting embodiment, example, or aspect, the processor can be programmable to be customized to distinct movement patterns of the user based on feedback provided by the at least one of the gyroscope and the magnetometer.

In one preferred and non-limiting embodiment, example, or aspect, the processor can be programmable to be customized to distinct movement patterns of the user through threshold memorization.

In one preferred and non-limiting embodiment, example, or aspect, the diet watch can further comprise a display screen positioned on the housing for providing a visual indication to the user of relevant information.

In one preferred and non-limiting embodiment, example, or aspect, the display screen can be a liquid crystal display (LCD) or a light emitting diode (LED) display.

In one preferred and non-limiting embodiment, example, or aspect, the magnetometer can use the earth's magnetic field as an input vector to determine the orientation of the user's hand in space and can output to the processor a signal related to the orientation of the user's hand in the space.

In one preferred and non-limiting embodiment, example, or aspect, the gyroscope can measure an angular velocity of the user's hand in the space and outputs to the processor a signal related to said angular velocity.

In one preferred and non-limiting embodiment, example, or aspect, the processor can determine from the signal output by the gyroscope related to said angular velocity of the user's hand in the space the orientation of the user's hand in the space or a change in the orientation of the user's hand in the space.

In one preferred and non-limiting embodiment, example, or aspect, the gyroscope can be a MEMS gyro chip.

In one preferred and non-limiting embodiment, example, or aspect, the feedback device can be a vibrator, a buzzer, a Light Emitting Diode (LED), or an electric shock device.

In one preferred and non-limiting embodiment, example, or aspect, the feedback device can provide a signal to the user if the user attempts to take another bite of food before the preset time interval has elapsed.

As can be seen, also disclosed herein is one preferred and non-limiting embodiment, example, or aspect diet watch comprising: a housing with an adjustable wristband attached thereto; a gyroscope and a magnetometer disposed within the housing for providing signals related to an orientation of a user's hand in space; a processor disposed within the housing and responsive to the signals from the gyroscope and the magnetometer to determine that a bite was taken by the user and starting a timer to countdown a preset time interval; and a feedback device operatively coupled to the processor for providing an indication to the user that another bite of food may be taken after the preset time interval has elapsed.

In one preferred and non-limiting embodiment, example, or aspect, the magnetometer can use the earth's magnetic field as an input vector to determine the orientation of the user's hand in space and can output to the processor a signal related to the orientation of the user's hand in the space.

In one preferred and non-limiting embodiment, example, or aspect, the gyroscope can measure an angular velocity of the user's hand in the space and can output to the processor a signal related to said angular velocity.

In one preferred and non-limiting embodiment, example, or aspect, the processor can determine from the signal output by the gyroscope related to said angular velocity of the user's hand in the space the orientation of the user's hand in the space or a change in the orientation of the user's hand in the space.

In one preferred and non-limiting embodiment, example, or aspect, the gyroscope can be a MEMS gyro chip.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A diet watch comprising:
a housing with an adjustable wristband attached thereto;
at least one of a gyroscope and a magnetometer disposed within the housing for providing a signal related to an orientation of a user's hand in space;
a processor disposed within the housing and operatively coupled to the at least one of the gyroscope and the magnetometer for using at least one signal from the at least one of the gyroscope and the magnetometer to determine that a bite was taken by the user and starting a timer to countdown a preset time interval; and
a feedback device operatively coupled to the processor for providing an indication to the user that another bite of food may be taken after the preset time interval has elapsed.

2. The diet watch of claim 1, further comprising a user interface having at least one button that allows a user to program the processor to determine when the motion of the user's arm corresponds to the bite being taken by the user and when to ignore movement of the arm.

3. The diet watch of claim 2, wherein the at least one button allows the user to set the preset time interval, to set the indication that the feedback device provides to the user, or the combination thereof.

4. The diet watch of claim 1, wherein the processor is programmable to be customized to distinct movement patterns of the user based on feedback provided by the at least one of the gyroscope and the magnetometer.

5. The diet watch of claim 4, wherein the processor is programmable to be customized to distinct movement patterns of the user through threshold memorization.

6. The diet watch of claim 1, further comprising a display screen positioned on the housing for providing a visual indication to the user of relevant information.

7. The diet watch of claim 6, wherein the display screen is a liquid crystal display (LCD) or a light emitting diode (LED) display.

8. The diet watch of claim 1, wherein the magnetometer uses the earth's magnetic field as an input vector to determine the orientation of the user's hand in space and outputs to the processor a signal related to the orientation of the user's hand in the space.

9. The diet watch of claim 1, wherein the gyroscope measures an angular velocity of the user's hand in the space and outputs to the processor a signal related to said angular velocity.

10. The diet watch of claim 9, wherein the processor determines from the signal output by the gyroscope related to said angular velocity of the user's hand in the space the orientation of the user's hand in the space or a change in the orientation of the user's hand in the space.

11. The diet watch of claim 1, wherein the gyroscope is a MEMS gyro chip.

12. The diet watch of claim 1, wherein the feedback device is a vibrator, a buzzer, a Light Emitting Diode (LED), or an electric shock device.

13. The diet watch of claim 1, wherein the feedback device provides a signal to the user if the user attempts to take another bite of food before the preset time interval has elapsed.

14. A diet watch comprising:
a housing with an adjustable wristband attached thereto;
a gyroscope and a magnetometer disposed within the housing for providing signals related to an orientation of a user's hand in space;
a processor disposed within the housing and responsive to the signals from the gyroscope and the magnetometer to determine that a bite was taken by the user and starting a timer to countdown a preset time interval; and
a feedback device operatively coupled to the processor for providing an indication to the user that another bite of food may be taken after the preset time interval has elapsed.

15. The diet watch of claim 14, wherein the magnetometer uses the earth's magnetic field as an input vector to determine the orientation of the user's hand in space and outputs to the processor a signal related to the orientation of the user's hand in the space.

16. The diet watch of claim 14, wherein the gyroscope measures an angular velocity of the user's hand in the space and outputs to the processor a signal related to said angular velocity.

17. The diet watch of claim 14, wherein the processor determines from the signal output by the gyroscope related to said angular velocity of the user's hand in the space the orientation of the user's hand in the space or a change in the orientation of the user's hand in the space.

18. The diet watch of claim 14, wherein the gyroscope is a MEMS gyro chip.
